(19) United States
(12) Patent Application Publication
(10) Pub. No.: US 2026/0358784 A1
(43) Pub. Date: Nov. 12, 2026

(54) Method and Manufacturing Installation for Producing Workpieces

(71) Applicant: Carl Zeiss Digital Innovation GmbH, Dresden (DE)

(72) Inventors: Franz-Georg Ulmer, Vogtareuth (DE); Daniel Goersch, Oberkochen (DE)

(21) Appl. No.: 19/714,231

(22) Filed: Jun. 19, 2026

Related U.S. Application Data
(63) Continuation of application No. PCT/EP2024/086509, filed on Dec. 16, 2024.

(30) Foreign Application Priority Data
Dec. 19, 2023 (WO) PCT/EP2023/086557

(51) Int. Cl. G05B 19/404; G05B 19/401; G05B 19/4097; G05B 19/4155

(52) U.S. Cl. CPC G05B 19/404; G05B 19/401; G05B 19/4097; G05B 19/4155

(57) ABSTRACT

A method for producing multiple workpieces uses a manufacturing installation having a manufacturing machine, a movable machine element, a controller, and a metrology device. The method obtains nominal workpiece data and a first control program with first control commands and first numerical control parameters that determine kinematic behavior of the movable machine element. A first workpiece is produced, inspected, and compared with desired workpiece characteristics to determine production errors. The first control program is adjusted based on the production errors to obtain an error-corrected control program with adjusted numerical control parameters. The method obtains past data pairs linking past numerical control parameters to resulting past measurement values and recent data pairs linking actual numerical control parameters to resulting actual measurement values. A reference sequence is defined from the adjusted numerical control parameters and nominal measurement values. Individually modified numerical control parameters are determined and used to produce a second workpiece.

### CROSS-REFERENCE TO RELATED APPLICATIONS

This application is a continuation of PCT Application No. PCT/EP2024/086509 filed Dec. 16, 2024, which claims priority to PCT Application No. PCT/EP2023/086557 filed Dec. 19, 2023. The entire disclosures of the above applications are incorporated by reference.

### FIELD

The present disclosure relates to a method for producing a plurality of workpieces using a manufacturing installation that comprises a manufacturing machine having a moveable machine element, comprises a machine controller configured to control the moveable machine element based on a control program, and comprises a metrology device configured to record measurement values on a produced workpiece in order to determine workpiece characteristics of the produced workpiece. The invention further relates to a manufacturing installation for producing a workpiece using the method, and to a computer program that facilitates implementation of such a method in a manufacturing installation.

### BACKGROUND

In many branches of industry, intense efforts are made to increase production output and product quality. Production quality is often defined in terms of whether the produced workpieces comply with predefined workpiece specifications. Workpieces not complying with the predefined specifications either require re-working or will be discarded, both of which reduces production output and efficiency. In order to monitor production quality, it has become known to integrate one or more metrology devices into the manufacturing installation and sometimes even directly into the manufacturing machine.

However, it is difficult to adjust a manufacturing process in real time if product quality decreases, because recording and evaluation of measurement results on workpieces during production or shortly after production requires time and the time delay may often be too large to be effectively used for closed-loop manufacturing control. Time-to-result in measurement processes is often significantly longer than production cycle times or period lengths of production process fluctuations.

Notwithstanding, quality control has been of utmost interest in industrial manufacturing processes for years in order to achieve both cost-efficient production and high product acceptance on the customer's side. There are many concepts and approaches for establishing quality control processes in the industrial manufacture of workpieces.

By way of example, U.S. Pat. No. 11,249,458 B2 discloses a control system including a controller that controls machining of a workpiece and including a photographing device that photographs an image of the workpiece under machining operation. The controller generates a three-dimensional model of the workpiece under machining operation based on the acquired image, compares the generated three-dimensional model and a three-dimensional model generated by a machining simulation with each other, and determines a presence or absence of a machining defect based on a result of the comparison. When the machining defect is present and re-machining is possible, a setting is modified depending on a cause of the machining defect and additional machining is executed based on the modified setting.

U.S. Pat. No. 11,049,236 B2 discloses a system and method for performing real-time quality inspection of objects. The system and method include a transport to move objects being inspected, allowing the inspection to be performed in-line. At least one optical acquisition unit captures optical images of the objects being inspected. The optical images are matched to CAD models of objects, and the matched CAD model is extracted. A laser with an illumination light beam has a wavelength in the violet or ultraviolet range and conducts scans of the objects, which are formed into three-dimensional point clouds. The point clouds are compared to the extracted CAD models for each object and the object is determined to be acceptable or defective based on the extent of deviation between the point cloud and the CAD model.

US 2021/0208568 A discloses a manufacturing system comprising: a communication module for receiving a three-dimensional model and control commands including manufacturing instructions for the manufacturing machine with respective reference values, tolerance values, and/or intervention tolerance values; a manufacturing module, wherein the model, the instructions, and the commands are used to manufacture an object; a calculating module using the three-dimensional model and the manufacturing instructions to calculate the control commands; and a measuring device having a communication module for receiving the three-dimensional model, a capture module using sensors to measure the manufactured object, captured for the reference values and/or the tolerance values and/or intervention tolerance values, and a checking module, wherein a divergence of the measured values from the applicable manufacturing reference values and an exceeding of the associated manufacturing tolerance values and/or the associated intervention tolerance values result in a control signal.

U.S. Pat. No. 9,383,742 B2 discloses a system and method for error compensation in positioning a complex-shaped gas turbine engine part during manufacturing thereof with a machine. Theoretical measurements for a plurality of control points on the part are first retrieved. Actual measurements for the control points are then acquired in a coordinate system of the machine. If an error between the actual and theoretical measurements is beyond a tolerance, a transformation matrix is computed. The transformation matrix represents a transformation to be applied to the coordinate system to adjust a pose thereof for compensating the error. The transformation matrix may be computed and applied to the coordinate system iteratively until the actual measurements are brought within tolerance. A machining program may then be generated for manufacturing the part accordingly.

EP 3 045 992 A1 discloses a method using a feedback loop for compensating errors occurring in a production process. The method comprises generating actual property data of at least one sample object produced in a production assembly according to a production model, performing a nominal-actual value comparison thereby generating deviation data, and automatically creating an adapted production model based on nominal property data and on the deviation data. The adapted production model is useable in an adapted production process for producing an adapted object in the production assembly, and differs from the nominal property data so that the errors occurring in the production process are at least partially compensated in the adapted production process.

EP 4 163 740 A1 discloses a method for automatically adapting at least one adaptable process parameter of a tooling machine such as a milling and/or turning tool, the tooling machine being part of a first or second manufacturing process for physically processing input work pieces into output work pieces. According to the method, at least one geometric feature of an output work piece is measured by a coordinate measuring machine, the geometric feature being a direct or indirect result of the processing with the tool. The measurement result is together with nominal measurement data of the geometric feature fed into a deterministic digital simulation of at least a part of the manufacturing process with a digital model such as a digital twin of the tooling machine and modelled process parameters, therein the adaptable process parameter of the tooling machine, simulating at least a deterministic behavior of the tooling machine relevant for an operation of its tool. The simulation is executed with varying of at least one of the modelled process parameters with the objective to emulate the measurement result. From the simulation with thus adapted modelled process parameters and based on nominal geometric data of the feature an adapted value for the adaptable process parameter is derived which enables an adapted operation of the tooling machine with respect to its tool resulting in a reduced difference between real and nominal geometric data of the feature.

U.S. Pat. No. 6,975,918 B2 discloses a production system for the series manufacture of products, comprising a processing device which, as a function of control commands, actuates a tool for processing one of the products, a measuring device for the automatic measuring of a geometric actual dimension at one of the processed products, a correcting device which is coupled to the processing device and to the measuring device and which compares the actual dimension with a preset target dimension which lies within a tolerance interval. The correcting device intervenes in a corrective manner in the control commands of the tool if the actual dimension lies outside an intervention interval which lies within the tolerance interval.

U.S. Pat. No. 11,036,203 B2 discloses a fabrication system for fabricating a three-dimensional object using processing circuitry. The processing circuitry estimates, according to a fabrication condition and fabrication data, a three-dimensional object to be fabricated according to the fabrication data and corrects the fabrication data according to an estimation result of the three-dimensional object estimated by the processing circuitry.

U.S. Pat. No. 8,090,557 B2 discloses a method for operating an industrial processing machine, a production machine or a manipulation robot. At least part of the operation of the industrial machine is simulated with the aid of a simulation model and the simulated results and real-time data from the operation of the industrial machine are stored. The simulation can be carried out in the industrial machine and if this is the case a parametric representation of the simulation model can be at least partly produced using a unit for this purpose. To produce the parametric representation, a data-systems connection can be created between the industrial machine and the unit, by means of an Intranet and/or an Internet connection. In addition, the simulation can be carried out in an external simulation unit, the latter having a data-systems connection to the industrial machine by means of an Intranet and/or an Internet connection.

WO 2018/204410 discloses a system comprising a first data link to a manufacturing system configured to create a run of parts based on a common engineering schematic, comprising a second data link to a metrology device configured to measure at least some parts in the run of parts to generate measurement data representing a physical shape of each part of the at least some parts, and comprising a machine learning system including one or more processors in communication with a computer-readable memory storing executable instructions, wherein the one or more processors are programmed by the executable instructions to at least: access a neural network trained, based on measurement data of past parts in the run of parts, to make a prediction about a future part in the run of parts; forward pass the measurement data through the neural network to generate the prediction about the future part in the run; and determine whether to output instructions for adjusting operations of the manufacturing system based on the prediction.

U.S. Pat. No. 10,180,667 B2 discloses a measurement technique integrated into a manufacturing machine in which the measurement results are interpreted by a trained artificial intelligence (AI). The AI determines new nominal control data based on the measurement results.

Some prior art approaches aim to make corrections even before a workpiece is actually produced. In other words, they try to implement some sort of forward error correction using knowledge gained from a previously produced workpiece in the production process of a subsequently produced workpiece. Such preemptive error correction appears very promising in order to optimize the efficiency and the output of a real, non-ideal manufacturing installation. Unfortunately, industrial manufacturing processes and installations can be very complex and it is often difficult to clearly identify all the causes and effects that can lead to undesired production errors and product deficiencies. It is therefore common practice to operate a real manufacturing installation with process parameters that are carefully selected in such a manner that desired product characteristics are likely met even if the actual production run is affected in an unexpected manner. In other words, it is accepted best practice to not push a manufacturing installation to its limits if high product quality is a major goal.

Preemptive error correction becomes even more difficult if the number of workpieces to be produced, i.e. the batch size, is small. It is particularly difficult to estimate the causes and effects leading to production errors if only a small number of samples is available. On the other hand, it is more and more desirable to produce workpieces in small batch sizes (up to a batch size of one) in order to enable customer specific variations.

In a more general field of endeavor, namely what is called systems theory, a behavioral approach is discussed. By way of example, a publication titled “Behavioral systems theory in data-driven analysis, signal processing, and control” by Ivan Markovsky and Florian Dörfler, published in Annual Reviews in Control, Vol. 52, 2021, explain such behavioral approach. In an example, an autonomous walking excavator based on the approach is described. In another publication titled “Bridging direct & indirect data-driven control formulations via regularizations and relaxations” by Florian Dörfler, Jeremy Coulson, and Ivan Markovsky, published in IEEE Transactions on Automatic Control, vol. 68, 2023, the authors discuss connections between sequential system identification and control for linear time-invariant systems, often termed indirect data-driven control, as well as a contemporary direct data-driven control approach seeking an optimal decision compatible with recorded data assembled in a Hankel matrix and robustified through suitable regularizations. Another publication titled “Data-driven model predictive control: closed-loop guarantees and experimental results” by Julian Berberich, Johannes Köhler, Matthias A. Müller, Frank Allgöwer, published in at-Automatisierungstechnik, vol. 69, 2021, provides a comprehensive review and describes a practical implementation of a model predictive control (MPC) framework using only measured data and no explicit model knowledge.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In view of the above, it is an object of the present invention to provide an improved manufacturing method and installation for efficiently producing workpieces with high product quality.

It is a further object to provide a method and installation that allow an efficient production of workpieces both in large and small batch sizes.

It is yet another object to provide a manufacturing method and installation that efficiently exploit knowledge gained during previous production runs in order to achieve high product quality.

According to an aspect, there is provided a method of producing a plurality of workpieces using a manufacturing installation that comprises a manufacturing machine having a moveable machine element, a machine controller configured to control the moveable machine element based on a control program, and a metrology device configured to record a plurality of measurement values on a produced workpiece in order to determine respective workpiece characteristics of the produced workpiece, the method comprising the steps of
obtaining nominal workpiece data defining respectively desired workpiece characteristics for the plurality of workpieces,
obtaining a first control program based on the nominal workpiece data, the first control program comprising a plurality of first control commands and a plurality of first numerical control parameters, wherein the first numerical control parameters determine a respective kinematic behavior of the moveable machine element during operation,
producing a first workpiece of the plurality of workpieces using the moveable machine element, the machine controller and the first control program in a first production run,
inspecting the first workpiece using the metrology device in order to obtain first measurement values representing actual workpiece characteristics of the first workpiece,
determining production errors by comparing the actual workpiece characteristics of the first workpiece and the desired workpiece characteristics,
adjusting the first control program based on the production errors to obtain an error corrected control program, the error corrected control program having adjusted numerical control parameters for compensating the production errors,
obtaining a data set that comprises a plurality of past numerical control parameters used during a plurality of past production runs on the manufacturing machine and comprises a plurality of past measurement values recorded on past workpieces produced by the plurality of past production runs, wherein the plurality of past numerical control parameters and the plurality of past measurement values are associated to each other based on the workpieces produced such that a first plurality of data pairs are formed, with each data pair of the first plurality of data pairs comprising past numerical control parameters and past measurement values resulting therefrom, and with the first plurality of data pairs representing a first temporal sequence of the past production runs,
obtaining a second plurality of data pairs that represent a temporal sequence of recent production runs, with each data pair of the second plurality of data pairs comprising respective actual numerical control parameters used during a respective one of the recent production runs and respective actual measurement values resulting therefrom,
defining a reference sequence of data pairs based on the adjusted numerical control parameters and based on nominal measurement values corresponding to the respectively desired workpiece characteristics,
determining individually modified numerical control parameters using the reference sequence of data pairs, using the data set comprising the first plurality of data pairs, and using the second plurality of data pairs, wherein the second plurality of data pairs are used as a starting sequence, and wherein the individually modified numerical control parameters define at least one data pair that extends the starting sequence based on the first plurality of data pairs and based on the nominal measurement values from the reference sequence of data pairs, and
producing a second workpiece of the plurality of workpieces using the moveable machine element, the machine controller and the error corrected control program in a second production run, wherein the individually modified numerical control parameters are used instead of the adjusted numerical control parameters.

According to another aspect, there is provided a manufacturing installation for producing a plurality of workpieces, the manufacturing installation comprising a manufacturing machine having a moveable machine element, comprising a machine controller configured to control the moveable machine element based on a control program, and comprising a metrology device configured to record a set of measurement values on a produced workpiece in order to determine workpiece characteristics of the produced workpiece, wherein the machine controller comprises at least one processor configured to obtain nominal workpiece data defining respectively desired workpiece characteristics for the plurality of workpieces, configured to obtain a first control program based on the nominal workpiece data, the first control program comprising a plurality of first control commands and a plurality of first numerical control parameters, wherein the first numerical control parameters determine a respective kinematic behavior of the moveable machine element during operation, configured to produce a first workpiece of the plurality of workpieces using the moveable machine element, the machine controller and the first control program in a first production run, configured to inspect the first workpiece using the metrology device in order to obtain first measurement values representing actual workpiece characteristics of the first workpiece, configured to determine production errors by comparing the actual workpiece characteristics of the first workpiece and the desired workpiece characteristics, configured to adjust the first control program based on the production errors to obtain an error corrected control program, the error corrected control program having adjusted numerical control parameters for compensating the production errors, configured to obtain a data set that comprises a plurality of past numerical control parameters used during a plurality of past production runs on the manufacturing machine and comprises a plurality of past measurement values recorded on past workpieces produced by the plurality of past production runs, wherein the plurality of past numerical control parameters and the plurality of past measurement values are associated to each other based on the workpieces produced such that a first plurality of data pairs are formed, with each data pair of the first plurality of data pairs comprising past numerical control parameters and past measurement values resulting therefrom, and with the first plurality of data pairs representing a first temporal sequence of the past production runs, configured to obtain a second plurality of data pairs that represent a temporal sequence of recent production runs, with each data pair of the second plurality of data pairs comprising respective actual numerical control parameters used during a respective one of the recent production runs and respective actual measurement values resulting therefrom, configured to obtain a reference sequence of data pairs based on the adjusted numerical control parameters and based on nominal measurement values corresponding to the respectively desired workpiece characteristics, configured to determine individually modified numerical control parameters using the reference sequence of data pairs, using the data set comprising the first plurality of data pairs, and using the second plurality of data pairs, wherein the second plurality of data pairs are used as a starting sequence, and wherein the individually modified numerical control parameters define at least one data pair that extends the starting sequence based on the first plurality of data pairs and based on the nominal measurement values from the reference sequence of data pairs, and configured to produce a second workpiece of the plurality of workpieces using the moveable machine element, the machine controller and the error corrected control program in a second production run, wherein the individually modified numerical control parameters are used instead of the adjusted numerical control parameters.

There is also provided a computer program comprising program code configured to carry out the following method steps, when the program code is executed on at least one processor of a manufacturing installation that comprises a moveable machine element and a metrology device configured to record a plurality of measurement values on a produced workpiece:
obtaining nominal workpiece data defining respectively desired workpiece characteristics for the plurality of workpieces,
obtaining a first control program based on the nominal workpiece data, the first control program comprising a plurality of first control commands and a plurality of first numerical control parameters, wherein the first numerical control parameters determine a respective kinematic behavior of the moveable machine element during operation,
producing a first workpiece of the plurality of workpieces using the moveable machine element, the machine controller and the first control program in a first production run,
inspecting the first workpiece using the metrology device in order to obtain first measurement values representing actual workpiece characteristics of the first workpiece,
determining production errors by comparing the actual workpiece characteristics of the first workpiece and the desired workpiece characteristics,
adjusting the first control program based on the production errors to obtain an error corrected control program, the error corrected control program having adjusted numerical control parameters for compensating the production errors,
obtaining a data set that comprises a plurality of past numerical control parameters used during a plurality of past production runs on the manufacturing machine and comprises a plurality of past measurement values recorded on past workpieces produced by the plurality of past production runs, wherein the plurality of past numerical control parameters and the plurality of past measurement values are associated to each other based on the workpieces produced such that a first plurality of data pairs are formed, with each data pair of the first plurality of data pairs comprising past numerical control parameters and past measurement values resulting therefrom, and with the first plurality of data pairs representing a first temporal sequence of the past production runs,
obtaining a second plurality of data pairs that represent a temporal sequence of recent production runs, with each data pair of the second plurality of data pairs comprising respective actual numerical control parameters used during a respective one of the recent production runs and respective actual measurement values resulting therefrom,
defining a reference sequence of data pairs based on the adjusted numerical control parameters and based on nominal measurement values corresponding to the respectively desired workpiece characteristics,
determining individually modified numerical control parameters using the reference sequence of data pairs, using the data set comprising the first plurality of data pairs, and using the second plurality of data pairs, wherein the second plurality of data pairs are used as a starting sequence, and wherein the individually modified numerical control parameters define at least one data pair that extends the starting sequence based on the first plurality of data pairs and based on the nominal measurement values from the reference sequence of data pairs, and
producing a second workpiece of the plurality of workpieces using the moveable machine element, the machine controller and the error corrected control program in a second production run, wherein the individually modified numerical control parameters are used instead of the adjusted numerical control parameters.

The new method and manufacturing installation combine two different approaches for achieving high product quality in a very efficient manner. On the one hand, the control program for controlling the manufacturing machine is optimized with a focus on locations and/or areas of a workpiece that are more critical than others in terms of production quality. Advantageously, production errors that may occur as a result of a non-optimized control program can thereby be diminished or even completely avoided. By way of example, a control program derived from nominal CAD data of the workpiece to be produced may lead to production errors at certain areas of the workpiece, because material thickness may already have been weakened as a result of previous machining steps. Based on material thickness and/or material temperature, a workpiece surface may deform more or less during machining. In some situations, it might therefore be advantageous to reduce a feed force and/or feed speed of a machining tool in order to diminish or even avoid surface deformation during the machining operation. In some situations, it might be advantageous to increase or decrease a feed stroke of the machining tool in order to compensate for surface deformation during the machining step. A control program derived from nominal CAD data may not have envisaged the incidence of such surface deformation under the load of the machine tool with the result that the workpiece surface is not produced as desired.

The new method involves inspecting a first workpiece produced under control of the first control program to determine production errors by comparing actual workpiece characteristics of the first workpiece and the desired workpiece characteristics. Such a comparison efficiently reveals error effects that become visible only after actual production. An error corrected control program is determined and comprises numerical control parameters adjusted in such a manner that production errors resulting from workpiece specific characteristics in response to machining operations are diminished or even avoided. Preferably, the comparison and correction are carried out workpiece area by workpiece area. Preferably, the numerical control parameters of the error corrected control program differ from the numerical control parameters of the first control program in dependence on spatial areas on the workpiece. The first control program and the error corrected control program may differ in some numerical control parameters, while other numerical control parameters are the same for both the first control program and the error corrected control program.

In some preferred example embodiments, determining the error corrected control program may be carried out using a CAM (Computer Aided Manufacturing) software tool that is implemented in the control architecture of the manufacturing installation. The CAM software tool may be implemented on a general purpose computer, which may be located in the vicinity of the manufacturing machine or remote from the manufacturing machine. In some preferred example embodiments, determining the error corrected control program may be carried out by first adjusting the CAD data and deriving the control program from the adjusted CAD data, and/or by adjusting a so-called production model derived from the original CAD data of the workpiece, with the original CAD data being maintained unadjusted.

Optimization of the control program by adjusting numerical control parameters based on locally dependent production errors is advantageously combined with a second corrective approach. The second corrective approach comprises modifying numerical control parameters of the control program with a focus on predictively compensating errors that might occur as a result of process variations. Advantageously, a data set comprising a plurality of past numerical control parameters used in a plurality of past production runs is used for determining numerical control parameters that are actually used for the production of the second and further workpieces.

The new method and manufacturing installation thus exploit knowledge about the behavior of the manufacturing installation gained over a plurality of past production runs using the manufacturing machine and gained from measurement values recorded on workpieces produced by the plurality of these past production runs. Preferably, the past production runs are carried out on the very same manufacturing machine that is later used for producing the new workpiece, although it is generally conceivable to transfer knowledge gained with one specimen of a manufacturing machine to another specimen of the same type of manufacturing machine. In any case, a history of past production runs is advantageously used for controlling a new production run in a most efficient manner.

The past production runs are production runs where the manufacturing machine including the moveable machine element is used for actually producing workpieces. Said workpieces may be of a same type and dimension as the workpieces to be produced in accordance with the new method, but it is within the context of the new method and installation that they may differ from the workpieces to be produced in one or both of type and dimension.

The workpieces produced by the past production runs are measured and the control parameters used in said production runs and the measurement values resulting from said production runs are recorded and respectively assigned to form respective data pairs, each representing the system behavior during an actual past production run. A first plurality of such data pairs is recorded in such a manner that each data pair represents an individual and real relationship between the numerical control parameters used during the respective workpiece production and the resulting workpiece characteristics. Accordingly, each data pair represents actual behavior of the manufacturing installation during an individual period of time. Moreover, the data set represents the development of the actual behavior over the time, i.e. a temporal development of the machine behavior. Advantageously, the data set may comprise the first plurality of data pairs arranged in a series of data pairs in such a manner that the series corresponds to the order of the past production runs. It is conceivable, however, that the data set comprises the first plurality of data pairs in a different order or arrangement, provided that the temporal development is still represented or can be retrieved, such as by exploiting appropriate meta data representing the order of the past production runs for instance. In other words, the data set represents an example temporal behavior of the manufacturing installation over a plurality of actual production runs recorded in the past.

In some preferred example embodiments, the first plurality of data pairs have been recorded “offline”, i.e. well before the upcoming production of new workpieces in accordance with the new method and installation. By way of example, the data set may comprise a plurality of data pairs recorded during production runs that took place at least one week or one month before the new workpiece is produced in accordance with the new method and manufacturing installation. Accordingly, there might be a substantial time gap between the date of recording the latest data pair of the data set and the current instance of time when a new workpiece is produced. A plurality of further workpieces may have been produced during this time gap without an update of the data set in some example embodiments.

In contrast, the second plurality of data pairs represent a temporal sequence of recent production runs, which means that the second plurality of data pairs represent production runs that precede the current workpiece production run in close temporal proximity, in particular with a time gap of less than one week, preferably less than one day, and further preferably less than 1 hour. The second plurality of data pairs are thus recorded “online” with respect to the current production run.

The production run for producing the second workpiece may therefore be seen as a continuation of the series of most recent production runs. These most recent production runs may advantageously include the first production run for producing the first workpiece in accordance with the new method and installation, but this is not mandatory.

In preferred example embodiments, the production run for the second workpiece is a direct continuation of a series of most recent production runs represented by the second plurality of data pairs, such that the second workpiece is the “next” workpiece of the series. In other example embodiments, however, a limited number of workpieces may have been produced between the last workpiece of the series, as represented by the last data pair of the second plurality of data pairs, and the next workpiece. By way of example, a limited number of workpieces may have been produced but not measured, such that no further most recent measurement values are available to form another data pair of the second plurality of data pairs. Advantageously, the limited number of non-measured workpieces is selected based on how stable the production process appears. For a production process that outputs a plurality of workpieces with very few variations in the workpiece characteristics, the limited number may be chosen higher than for a production process that outputs a plurality of workpieces with higher variations.

In any case, the time gap between the latest data pair of the second plurality of data pairs and the current production run is shorter than any time period over which defined production process fluctuations that affect product quality typically occur. In contrast, the time gap between the latest data pair of the first plurality of data pairs and the current production run is typically longer than such time period. In addition, the number of data pairs of the first plurality of data pairs is preferably higher than the number of data pairs of the second plurality of data pairs. The data set therefore represents a longer history of the installation behavior than the more recent second plurality of data pairs, when the manufacturing installation is in steady operation. In some preferred embodiments, the length T of the temporal sequence of past production runs, i.e. the number of data pairs of the first plurality of data pairs, is

T≥(m+1)L−1,

i.e. Tis at least (m+1)L−1, with L being the length of the temporal sequence of recent production runs, i.e. the number of data pairs of the second plurality of data pairs, and m being the number of inputs to the system, i.e. the number of numerical control parameters that can be modified.

The new method and manufacturing installation make beneficial use of the second plurality of data pairs as a defined starting sequence that is to be extended by at least one new data pair. The at least one new data pair is determined in such a manner that it provides modified control parameters for the upcoming production run or production runs in combination with the desired workpiece characteristics of the workpieces to be produced. Such desired workpiece characteristics are represented by the reference sequence, which defines the desired workpiece characteristics in combination with control parameters adjusted, as explained before, and in combination with nominal measurement values. The nominal measurement values are typically derived from the nominal workpiece characteristics, which may be defined by a CAD data set for instance.

Generally, the reference sequence can be considered as describing the theoretical or intended behavior of the manufacturing installation without taking into account real process fluctuations that usually affect any real production run. In contrast, the data set including the first plurality of data pairs and the second plurality of data pairs each represent real behavior of the machine installation during a plurality of past and previous production runs, respectively.

In the new method and manufacturing installation, the modified numerical control parameters are determined as numerical control parameters that lead to the desired workpiece characteristics as closely as practically possible, taking into account the real behavior of the manufacturing installation under varying environmental parameters, such as temperature, humidity etc., and further effects including wear and tear or material variations. The modified numerical control parameters are advantageously determined as part of at least one new data pair that extrapolates the starting sequence, taking into account the desired workpiece characteristics represented by the reference sequence, and taking into account the history of the past production runs. The starting sequence that is extrapolated is defined by the sequence of recent production runs, i.e. by the second plurality of data pairs.

In some preferred example embodiments, the modified numerical control parameters are determined as an approximation of the reference sequence with the additional constraint that the extrapolation of the starting sequence, as represented by the second plurality of “real” data pairs, has to conform to the real behavior of the manufacturing installation, as represented by the data set. In one example embodiment, the modified numerical control parameters may be determined by minimizing the expression

$${‖ {w}_{f} - {w}_{r} ‖}_{2}^{2} = {\sum }_{k = 1}^{{T}_{f}} {‖ {w}_{f}^{k} - {w}_{r}^{k} ‖}_{2}^{2}$$

wherein wᵣ designates the reference sequence, w_{f} designates a sequence of future data pairs having length T_{f}, with each future data pair including modified numerical control parameters for the next T_{f}, production runs. The sequence w_{f} is a continuation of the starting sequence wᵢₙᵢ of the second plurality of data pairs in such a manner that the concatenated sequences wᵢₙᵢ+w_{f} can be derived as a linear combination of the first plurality of data pairs.

The new method and manufacturing installation are thus based on the assumption that the manufacturing installation can largely be modelled as a linear and time-invariant (LTI) system. Conventionally, such LTI systems are modelled using state-space approaches and/or using Laplace transformations and what is called transfer functions. However, such approaches require extensive advance effort for determining the system model. The new approach allows to proceed without model building just by exploiting the data collected over the plurality of past production runs represented by the above-mentioned data set. By extrapolating the second plurality of data pairs under the constraints of the reference sequence on the one hand, and the data set on the other hand, the real behavior of the manufacturing installation over past and recent production runs is exploited in order to find a well suited set of numerical control parameters for the next production run or next production runs. Since no model has to be established, the new method and manufacturing installation can be implemented faster. They are able to quickly react to changing environmental parameters, such as temperature, humidity etc., and to other effects that affect product quality, including wear and tear on the moveable machine element or variations in the materials used. Recent variations are advantageously represented in the second plurality of data pairs acting as a starting sequence that is extrapolated by at least one data pair comprising the modified control parameters for the upcoming production run.

The new method and manufacturing installation therefore implement predictive error correction based on production data that is collected during actual production runs in an efficient manner. The new method and manufacturing installation thus allow producing workpieces with high product quality in a very efficient manner. The above-mentioned object is completely achieved.

In a preferred refinement, the method further comprises the steps of recording second measurement values on the second workpiece, associating the individually modified numerical control parameters used for production of the second workpiece and the second measurement values to form a most recent data pair, adding the most recent data pair to the second plurality of data pairs to form an updated temporal sequence of recent production runs, and producing a third workpiece of the plurality of workpieces using the moveable machine element, the machine controller and the error corrected control program in a third production run, wherein further individually modified numerical control parameters are used instead of the adjusted numerical control parameters, and wherein the further individually modified numerical control parameters are determined using the reference sequence of data pairs, using the data set comprising the first plurality of data pairs, and using the updated temporal sequence of recent production runs.

In this refinement, the data determined and collected in connection with the production run for producing the second workpiece is efficiently used to update the available data for a subsequent production run. Therefore, closed loop control is efficiently implemented and updated on-the-fly from one production run to the next. The new method and manufacturing installation are therefore capable of immediately reacting to changes and variations in the production environment. At the same time, the refinement benefits from the initial approach for optimizing the control program with respect to diminishing local production errors in response to workpiece deformation under the load of a machining operation. Product quality and production efficiency are further increased.

In a further refinement, the first workpiece, the second workpiece and the third workpiece are individual specimens of a same type of workpiece.

In this refinement, the first workpiece, the second workpiece and the third workpiece have the same type and have nominally same dimensions. The refinement even further increases product quality and is very effective for series production of workpieces.

In a further refinement, a plurality of first workpieces are iteratively produced using the moveable machine element and inspected using the metrology device, wherein production errors are determined for each of the plurality of first workpieces, and wherein the step of adjusting the first control program is iteratively carried out based on a respective one of the plurality of first workpieces at a time.

In this refinement, the adjusted control parameters are determined using an iterative approach. Advantageously, workpiece specific production errors can be thus minimized by improving the error corrected control program from one iteration step to another. In some preferred embodiments, a different set of numerical control parameters and/or numerical parameters relating to different areas on the workpiece are selectively optimized from one iteration step to another. In other example embodiments, a same set of numerical control parameters is iteratively optimized from one iteration step to another.

In a further refinement, the first workpiece is produced in a plurality of production steps each using the moveable machine element, wherein the first workpiece is iteratively inspected using the metrology device after each of the plurality of production steps, and wherein the step of adjusting the first control program is iteratively carried out based on the production errors after each of the plurality of production steps.

This refinement can be used as an alternative iterative approach, or in addition to the afore-mentioned iterative approach using a plurality of first workpieces. In the latter case, a plurality of iteration steps can be carried out on each of the plurality of workpieces. According to this refinement, measurement values are repeatedly recorded on a (respective) first workpiece. This refinement allows a very efficient adjustment of numerical control parameters for different areas of the first workpiece. It is particularly beneficial for complex workpieces that require a high number of production steps. In general, it further improves production quality.

In a further refinement, the step of iteratively adjusting the first control program comprises determining the adjusted numerical control parameters in accordance with a feedback-based control loop mechanism having an integral control term.

This refinement is very efficient for minimizing workpiece-specific production errors. The feedback loop with the integral control term helps to find optimized numerical control parameters in an efficient manner. In addition, feedback-based control loop mechanisms are generally known to those skilled in the art from so-called PID control mechanisms and can therefore be implemented using existing control tools. Advantageously, the feedback-based control loop mechanism does not require a linear process. Non-linear adjustment is likewise conceivable, as is known from other feedback-based control loop mechanisms. This refinement advantageously adds to the second approach implemented by the new method using the above-mentioned data set, which works best for linear systems.

In a further refinement, the step of iteratively adjusting the first control program comprises determining the adjusted numerical control parameters in accordance with a feedback-based control loop mechanism further having a proportional control term.

This refinement even further increases efficiency. A proportional control term helps to reduce the number of iterations required for finding the best numerical control parameters for a specific type of workpiece.

In a further refinement, the first plurality of data pairs comprise a plurality of calibration data pairs recorded during a plurality of selected calibration runs using the manufacturing machine and the moveable machine element, with the calibration data pairs each comprising numerical control parameters individually modified in accordance with a calibration strategy.

In this refinement, the data set representing the history of past production runs is collected by exploring the behavior of the machine installation using deliberate changes in the numerical control parameters. This refinement allows to explore the parameter space in a very efficient manner. In some example embodiments, environmental parameters, such as temperature, humidity or brightness may be deliberately change within the plurality of calibration production runs in addition to changing numerical control parameters in order to even more explore the behavior of the manufacturing installation.

In a further refinement, the calibration strategy comprises deliberately changing the numerical control parameters from one calibration production run to another calibration production run of the plurality of calibration runs. In some example embodiments, the numerical control parameters may be changed randomly from one calibration production run to another calibration production run.

This refinement even more helps to efficiently explore the behavior of the manufacturing installation. The deliberate changes add variety and therefore help to explore system behavior in short time. Randomly changing the control parameters particularly includes pseudo-random changes, as can be derived from mathematical algorithms. Such changes in the control parameters increase the chances to examine the system behavior in a very efficient manner.

In a further refinement, a plurality of calibration workpieces are produced by the plurality of calibration runs, with the plurality of calibration workpieces each forming individual specimens of a same type of workpiece.

In this refinement, the plurality of calibration workpieces each are of the same type, but the numerical control parameters are deliberately changed from one production run to another. The refinement facilitates recording and processing of the production data and, therefore, contributes to an even further improvement of production efficiency. In some example embodiments, the calibration workpieces are of the same type of workpiece as the new workpiece to be produced. In other example embodiments, the calibration workpieces are of a generic type and the data set is used for producing a variety of workpieces of different types and/or sizes.

In a further refinement, the step of defining the reference sequence of data pairs comprises determining a plurality of reference data pairs each comprising the adjusted numerical control parameters and the nominal measurement values.

In this refinement, the reference sequence comprises not only one, but a plurality of reference data pairs that advantageously may be the same from one reference data pair to another. The refinement can easily be implemented and nevertheless provides appropriate forward error correction by extrapolating the starting sequence with a plurality of intended “ideal” data pairs.

In a further refinement, determining the modified numerical control parameters comprises determining a plurality of modified numerical control parameters in a sequential order having a start, and wherein modified numerical control parameters from the start of the sequential order are selected for producing the workpiece.

In this refinement, a plurality of data pairs are determined as a sequential concatenation of the initial starting sequence, but only the first data pair of the plurality of data pairs is actually used for producing the second workpiece. The remaining data pairs may be discarded. Instead of using the remaining data pairs for actual workpiece production, the modified numerical control parameters from the first data pair and measurement values on the second workpiece resulting therefrom after actual workpiece production are associated to form a new most recent data pair that may be added to the second plurality of data pairs. The refinement provides an improved forward error correction for both slowly varying, long-term changes and fast-varying, short-term changes in the production environment.

In a further refinement, the first temporal sequence of the past production runs is subdivided into a plurality of past temporal subsequences using a sliding window procedure, wherein the plurality of past temporal subsequences from the data set are arranged in a Hankel matrix, and wherein the modified numerical control parameters are determined in such a manner that data pairs comprising the modified numerical control parameters are comprised by an image of the Hankel matrix.

This refinement allows for a very efficient determination of the modified numerical control parameters. The refinement can be implemented on almost any conventional computer hardware using well-known quadratic solvers.

In a further refinement, the Hankel matrix is approximated using a low rank approximation computed from a singular value decomposition of the Hankel matrix.

This refinement is particularly advantageous, because it reduces negative effects of noise in the data set of the first plurality of data pairs. Accordingly, product quality of the workpieces produced under varying real-world conditions is further increased.

In a further refinement, the first plurality of data pairs is updated at defined time intervals using the modified numerical control parameters.

In this refinement, the data set including the first plurality of data pairs is updated from time to time. The defined time intervals for such an update are much longer than any updates to the second plurality of data pairs. The refinement advantageously increased production error compensation resulting from long-term changes in the manufacturing installation.

It goes without saying that the aforementioned features and those yet to be explained below can be used not only in the combination specified in each case but also in other combinations or on their own, without departing from the scope of the present invention.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a schematic illustration of an example embodiment of the novel manufacturing installation,

FIG. 2 shows a flowchart illustrating an example embodiment of a method for exploring an actual behavior of a manufacturing installation,

FIG. 3 shows a flowchart illustrating an example embodiment for adjusting numerical control parameters by producing on or more first workpieces, and

FIG. 4 shows a flowchart illustrating an example embodiment for producing second and further workpieces.

In the drawings, reference numbers may be reused to identify similar and/or identical elements.

### DETAILED DESCRIPTION

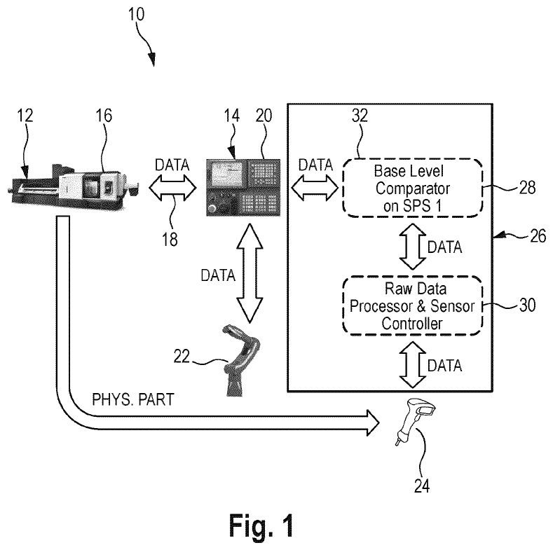

FIG. 1 shows an example embodiment of the new manufacturing installation 10 in a schematic illustration. Manufacturing installation 10 comprises a manufacturing machine 12 that is controlled by an associated machine controller 14. Manufacturing machine 12 is shown here as a multi-axis machine tool that is capable of at least one of cutting, milling, drilling, turning and/or grinding a workpiece. Suitable machine tools are commercially available from a plurality of vendors such as DMG Mori Seiki, Chiron, Heller and many others. Additionally or alternatively, manufacturing machine 12 may be a machine that is capable of welding, bending, pressing, additively and/or chemically manufacturing a workpiece. Without limitation, any type and brand of a controller-controlled manufacturing machine that is capable of producing a workpiece from a raw material based on a CAD data set could be used here. All these manufacturing machines have at least one moveable machine element 16 controlled by machine controller 14, as is readily known to those skilled in the art. The at least one moveable machine element 16 may be a tool head that carries a cutting tool, milling tool, drilling tool, turning tool, grinding tool, welding tool, bending tool, pressing tool and/or a laser processing tool. Moreover, the moveable machine element may be or may comprise an operating valve in a manufacturing installation that processes fluids and controls chemical reactions via a moveable machine element in the valve, for instance.

Manufacturing machine 12 and machine controller 14 exchange control data 18. The control data may include, in particular, control commands and numerical control parameters, as is known to those skilled in the art. By way of example, the control program may conform to what is known G-code or M-code and a numerical control parameter may define the rotational speed of a tool head or a distance of travel of the tool head, while the control command may activate a motor driving the moveable machine element.

The control commands are first determined based on a data set defining desired workpiece characteristics, such as a CAD data set indicated at reference numeral 20 in FIG. 1. A first workpiece (not shown here) is produced during a production run using the control data 18 in a manner known per se to those skilled in the art.

When the production run is finished, the workpiece may be removed from the manufacturing machine 12, preferably by an automated handling system such as robot 22. Preferably, automated removal is synchronized with manufacturing machine controller 14. In some example embodiments, controller 14 may therefore exchange further control data with handling system 22 or even control handling system 22.

In some example embodiments, handling system 22 automatically transfers the workpiece produced in the first production run to a metrology device 24. Metrology device 24 may be a coordinate measuring machine (CMM) using a contact-type and/or a non-contact-type probe, a computed tomography device, an industrial microscope, a laser scanner and/or any other metrology device suitable and configured for inspecting the workpiece with respect to its workpiece characteristics. Optical metrology with cameras and/or laser scanners is particularly attractive in the field of machining, additive manufacturing (3D printing) and other forming processes. However, measurement technology and inspection are not limited to dimensional measurement technologies. Other defect detection methods are also conceivable, such as deflectometry, eddy current analysis, surface roughness profilometers, acoustic measurements, etc.

Metrology device 24 may be a coordinate measuring machine, such as offered and sold by Carl Zeiss Industrielle Messtechnik GmbH, Germany, and is preferably located in the vicinity of manufacturing machine 12 and preferably configured to automatically inspect the workpiece using a predefined inspection plan. In some example embodiments, metrology device 24 may be configured to automatically measure 3D point cloud data of measurement points recorded on the workpiece in order to determine dimensional and/or geometrical characteristics of the workpiece in accordance with the predefined inspection plan. The inspection plan may also be determined based on the CAD data set 18. In other example embodiments, metrology device 24 may be a probing head integrated into manufacturing machine 12, or a probing head that can selectively be introduced into manufacturing machine 12, in order to record measurement values on the workpiece while it is still fixed in the manufacturing machine 12. In yet another example embodiment, metrology device 24 may be a hand-held device, such as a hand-held 3D laser scanner.

In any case, metrology device 24 is a physical inspection device capable of and configured for recording measurement/inspection values on the workpiece, which measurement/inspection values represent actual workpiece characteristics. Preferably, automated test sequences and algorithmic interpretation of the results are implemented, such as DIN-ISO-compliant point cloud evaluation, CAD rule geometry comparisons, form and position evaluations, etc. In some preferred example embodiments, software tools commercially available from Carl Zeiss Industrielle Messtechnik GmbH, Germany, are used, such as the software tools Calypso (for regular geometries), Caligo (for free-form surfaces), Gear Pro (especially for measuring gears), GOM Inspect and/or GOM Volume Inspect.

In FIG. 1, manufacturing installation 10 further comprises a correction controller 26 that is configured to carry out at least one of the method steps explained further down below. In preferred example embodiments, correction controller 26 is implemented as one or more software components comprising executable software code that is executed on one or more hardware processors in a manner readily known to those skilled in the art. The one or more hardware processors may be commercially available microprocessors from Intel, AMD, Apple, IBM, Fairchild, ARM or others. In some example embodiments, the software components implementing the correction controller 26 may be installed and/or executed on commercially available computer hardware operating one or more of commercially available computer hardware operating systems, such as Windows, Linux, MacOS. In some example embodiments, the software components implementing the correction controller 26 may be installed and/or executed on one or more virtual machines, such as virtual machines based on Hyper-V, Powershell and/or Kybernetes Clusters. The software components implementing the correction controller 26 may be installed on hardware already present in a conventional manufacturing installation, such as the hardware implementing machine controller 14. By way of example, there are programmable logic controllers (PLCs) acting as machine controllers and implemented on hardware that is similar to hardware of a conventional personal computer running an operating system like Windows or Unix/Linux. The functionality of the correction controller 26 may also be implemented on such a hardware platform. In yet further example embodiments, the software components implementing the functionality of the correction controller 26 may be installed on cloud computers and/or edge computers of a computer network.

Correction controller 26 may include a user interface (not shown here) for allowing user interaction, such as a computer display, a keyboard, a mouse, a trackball etc. In FIG. 1, the example embodiment further comprises a functional module 28 that is called Base Level Comparator in the following and is implemented as a software module that facilitates at least one of the following method steps:
obtaining nominal workpiece data defining desired workpiece characteristics for the workpiece,
obtaining a control program comprising a plurality of control commands and a plurality of numerical control parameters, with the numerical control parameters each determining a kinematic behavior of the moveable machine element during a production run,
obtaining a data set that comprises a plurality of past numerical control parameters used during a plurality of past production runs on manufacturing machine 12 and comprises a plurality of past measurement values recorded on workpieces produced by the plurality of past production runs, wherein the plurality of past numerical control parameters and the plurality of past measurement values form a first plurality of data pairs representing a first temporal sequence of the past production runs; the data set may preferably comprise the first plurality of data pairs arranged in a Hankel matrix having a defined rank,
obtaining a second plurality of data pairs that represent a temporal sequence of recent production runs on manufacturing machine 12, with each data pair of the second plurality of data pairs comprising respective numerical control parameters actually used during a respective one of the recent production runs and respective actual measurement values resulting therefrom,
obtaining a reference sequence of data pairs based on the nominal numerical control parameters and based on nominal measurement values corresponding to the nominal workpiece data,
determining modified numerical control parameters using the reference sequence of data pairs, using the data set comprising the first plurality of data pairs, and using the second plurality of data pairs as a defined starting sequence, wherein the modified numerical control parameters define at least one data pair that extends the defined starting sequence based on the first plurality of data pairs and based on the reference sequence of data pairs, and
transferring the modified numerical control parameters to machine controller 14 for a next production run.

By way of example, a feed stroke of a cutting tool may be increased and the cutting tool may thus be moved a small amount further into the workpiece during machining compared to what would have been the case if nominal or adjusted numerical control parameters were used in order to compensate for increasing wear of the cutting tool over a plurality of production runs.

In the example embodiment shown, correction controller 26 optionally comprises a functional module 30 termed Raw Data Processor & Sensor Controller in FIG. 1. Software module 30 operates as a metrology sensor adapter configured to generate formatted point cloud data in a predefined format from raw measurement values obtained by metrology device 24. The formatted point cloud data preferably represent a produced workpiece by a plurality of 3D points relative to a predefined coordinate system in a standardized form, such that various types and brands of metrology devices 24 may be used to communicate with Base Level Comparator 28. Functional modules 28, 30 may exchange data with each other and with machine controller 14 or metrology device 24, respectively, as indicated in FIG. 1. Preferably, correction controller 26 further comprises a dedicated machine adapter configured to translate error correction commands into the plurality of modified control commands and parameters for a specific type and brand of machine controller 14 used in the respective manufacturing installation.

With respect to further details and variations of such a manufacturing installation, reference is made to applicants co-pending international patent application WO 2024/037769 A1, filed on 30 Jun. 2023 with the European Patent Office, which is incorporated by reference herewith in its entirety. As described above, one or more method steps of the new method may be implemented on the Base Level Comparator described in more detail in this co-pending application. In addition or alternatively, one or more method steps of the new method may be implemented on what is termed SOMM High Level Controller in WO 2024/037769 A1. By way of example, a data set comprising a first plurality of data pairs may be recorded on one manufacturing machine and later obtained on another manufacturing machine via the High-Level Controller.

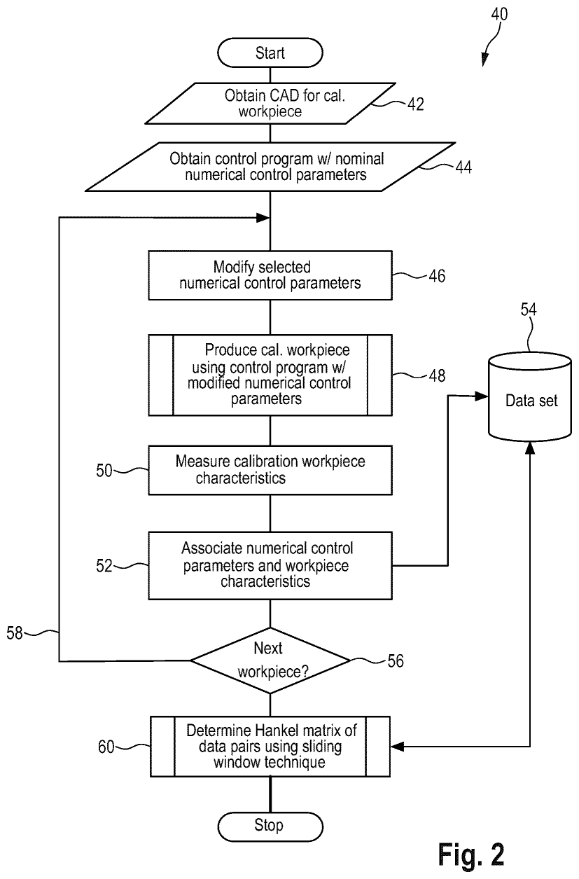

FIG. 2 shows an example embodiment of a preferred method 40 for exploring the behavior of the manufacturing installation 10 in order to form a data set that can later be used for efficiently producing high quality workpieces with the manufacturing installation 10. In other words, method 40 is an example embodiment for recording an actual production history of manufacturing installation 10.

According to step 42, nominal workpiece characteristics for a calibration workpiece (not shown here) are obtained. The nominal workpiece characteristics may be defined in a CAD data file. Based on the nominal workpiece characteristics, and as shown at reference numeral 44, a control program comprising control commands and nominal numerical control parameters is determined in a manner known to those skilled in the art. At step 46, however, one or more nominal numerical control parameters are deliberately changed. Preferably, the respective changes are limited such that predefined thresholds are not exceeded. This helps to keep the manufacturing installation within its usual operating limits. By way of example, one or more nominal numerical control parameters may randomly be changed within limits of up to 20%, preferably up to 10% with respect to the respective nominal numerical control parameter.

At step 48, a calibration workpiece is produced using the manufacturing installation 10 and the control program with the modified numerical control parameters. According to step 50, the calibration workpiece is inspected in order to determine actual workpiece characteristics of the calibration workpiece. According to step 52, the modified numerical control parameters and the workpiece characteristics of the calibration workpiece resulting therefrom are associated. In some preferred example embodiments, the modified numerical control parameters and the associated workpiece characteristics form a data pair wₖ=(uₖ, yₖ) comprising an input vector uₖ containing the modified numerical control parameters and an output vector yₖ containing the measurement values representing the workpiece characteristics. The data pair wₖ is stored in data set 54.

At step 56, it is decided if another calibration workpiece is to be produced. If in the affirmative, the method loops back to step 46, as is shown at reference numeral 58 and another calibration workpiece is produced with another set of deliberately modified control parameters. If a predefined number T of calibration workpieces is produced, the data pairs wₖ are preferably arranged in a sequence according to the temporal order of the calibration workpieces produced, such that a temporal sequence w_{d}=(w₁, w₂, w₃ . . . , w_{T}) of the calibration production runs is established.

According to step 60, a sliding window technique may be used to split the temporal sequence w_{d}=(w₁, w₂, w₃ . . . , w_{T}) into a plurality of subsequences of length L<T. The subsequences may advantageously be arranged in a Hankel matrix H_{L}(w_{d}) as follows

$${H}_{L} ( {w}_{d} ) = [ \begin{matrix}{w}_{1} & … & {w}_{T - L + 1} \\ ⋮ & ⋱ & ⋮ \\ {w}_{L} & … & {w}_{T}\end{matrix} ]$$

and also stored in data set 54. As a result, data set 54 comprises a plurality of past numerical control parameters uₖ used during a plurality of past production runs on manufacturing machine 12, and comprises a plurality of past measurement values yₖ recorded on (calibration) workpieces produced by the plurality of past production runs. The plurality of past numerical control parameters and the plurality of past measurement values are associated to each other such that a first plurality of data pairs wₖ=(uₖ, yₖ) are formed, with each data pair wₖ comprising past numerical control parameters uₖ and past measurement values yₖ resulting therefrom. The first plurality of data pairs wₖ thus represent a temporal sequence w_{d} of the past production runs.

The predefined number T is preferably selected such that the Hankel matrix H_{L}(w_{d}) reaches its maximal theoretical rank which can be proven to be

rank H_{L}(w_{d})=mL+n

with n representing an estimated upper bound of the number of hidden states of the system, i.e. manufacturing installation 10. Any sequence w of data pairs that is part of the image of Hankel matrix H_{L}(w_{d}) is a “valid” sequence that can be achieved with manufacturing installation 10. Verification can be performed by the condition

rank [H_{L}(w_{d})w]=rank H_{L}(w_{d})

In general, one can say that any valid sequence w represents a trajectory in a parameter space that is spanned by the temporal sequence w_{d}=(w₁, w₂, w₃ . . . , w_{T}) of the first plurality of data pairs wₖ. This is advantageously used in the following to determine modified numerical control parameters for a new production run on manufacturing installation 10.

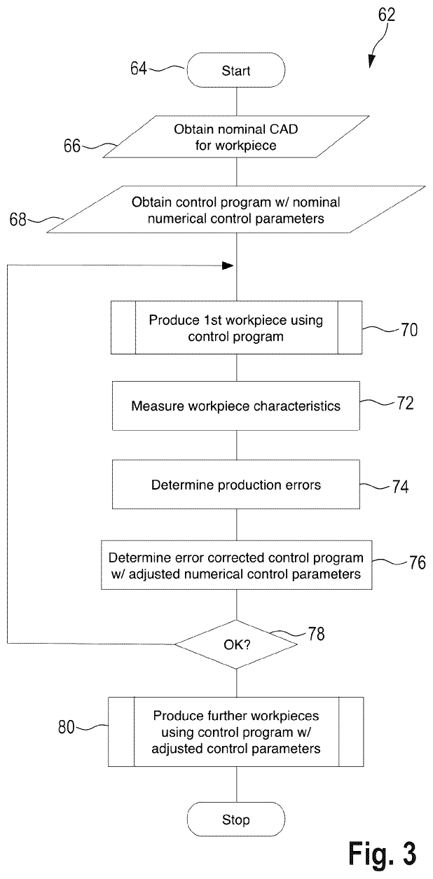

A first part 62 of an example embodiment of the new method will now be explained with reference to the flowchart in FIG. 3. According to step 66, nominal workpiece characteristics for a first workpiece (not shown here) are obtained. The nominal workpiece characteristics may be defined in a CAD data file. Based on the nominal workpiece characteristics, and as shown at reference numeral 68, a control program comprising control commands and nominal numerical control parameters is determined in a manner known to those skilled in the art. According to step 70, a first workpiece is produced using the control program with the nominal numerical control parameters. According to step 72, the first workpiece is inspected using metrology device 24 to obtain actual workpiece characteristics of the first workpiece. According to step 74, production errors resulting from workpiece-related characteristics are determined by comparing the actual workpiece characteristics and the nominal workpiece characteristics. According to step 76, an error corrected control program with adjusted numerical control parameters is determined. By way of example, a numerical control parameter representing a feed stroke of a machining tool may be increased in order to compensate for an evasive movement of a workpiece surface during the machining operation as a result of a deformation under the load of the machining operation. In general, numerical control parameters are adjusted in dependence of a workpiece area where production errors have been detected in step 74.

According to step 78, the method steps 70 to 76 may be repeated in an iterative approach. The iterative approach may be based on the production of a plurality of first workpieces, wherein each first workpiece of the plurality of first workpieces is produced with another set of adjusted numerical control parameters. Step 78 may comprise a decision based on the number of iterations and/or a decision based on whether or not an amount of adjustments of the numerical control parameters falls under a predefined threshold.

In another example embodiment, the iterative approach may be based on the production of a single workpiece in a plurality of production steps, wherein different surfaces of the workpiece are machined one or several times, and wherein the inspection step 72 is carried out after a respective workpiece surfaced is processed. In some further example embodiments, the both iterative approaches may be combined such that the steps 72, 74, 76 are iteratively repeated for a plurality of workpiece surfaces of a plurality of first workpieces.

Some example approaches for determining the adjusted numerical control parameters in accordance with step 76 are now explained. Manufacturing machine 12 may be mathematically modelled as a—potentially nonlinear—mapping S from a space X into itself. Space X represents a set of states describing relevant properties of workpieces processed by manufacturing machine 12. Since the system is influenced by internal and external factors, it may be assumed that S further depends on a parameter λ∈Λ representing those influences:

S:X×A→X

It may be assumed that some components of parameter λ originate from factors that cannot be controlled. Therefore, space Λ may be decomposed into a space of controlled parameters A and a space of uncontrolled parameters B. Hence each λ∈Λ=A⊕B can be represented as an ordered pair λ=(α, β) with α∈Λ and β∈B. A one-step or a multi-step machining process of a single first workpiece or of a plurality of first workpieces may be applied. In any case, the control parameters α have to be computed with the aim to modify the state of a workpiece starting at an initial state x₀ and reaching a target state x_{*}.

In order to now determine the parameters α, there is introduced a mapping A(x, ξ) with A:X×X→A, which predicts control parameters α depending on an initial state x and a target state ξ. In the case of a milling or turning machine, by way of example, this could be a CAM module capable of creating a theoretical machining path which transfers the initial workpiece state x into the desired target state ξ.

In a multi-part scenario, processing of a workpiece may be considered as a one-step procedure with no intermediate feedback and no intermediate correction steps. Compensation of the uncontrolled parameters β may be determined in an iterative manner from workpiece to workpiece. An auxiliary state variable ξ∈X can be introduced, which state variable only serves for the prediction of the control parameters α. Replacing the control parameter α by its estimation A(x, ξ), the problem to be solved can be formulated as a root finding problem for the auxiliary workpiece state ξ

F(ξ):=S(x,A(x,ξ),β)−x_{*}=0

Transforming this equation into the fix-point problem ξ=ξ−F(ξ), the following iteration scheme results

xⱼ₊₁=S(x₀,A(x₀,ξⱼ),β)

ξⱼ₊₁=ξⱼ−(xⱼ₊₁−x_{*})

with ξ₀=x_{*} and j=0, 1, . . . . It is noted that the prediction of the control parameters αⱼ and the mapping xⱼ of the workpiece states always use x₀, which is the design representation for the assumption that every step represents the processing of a new workpiece.

By noticing that the update of the corrected surface has the form of a PID controller with an integral term only, adding a proportional term leads to an extended iteration scheme:

xⱼ₊₁=S(x₀,A(x₀,ξⱼ),β)

ξⱼ₊₁=ξⱼ+(Kₚ+Kᵢ)(xⱼ₊₁−x_{*})−Kₚ(xⱼ−x_{*})

with ξ₀=x_{*} and the constants Kₚ, Kᵢ∈ [symbol] to be chosen appropriately.

The integral term provides convergence of the iterative scheme and the proportional term increases efficiency. The proposed iteration can thus be described as follows:
1 The first step corresponds to the computation of a theoretical machining path αⱼ₊₁ by a CAM module, for instance, mapping the initial surface x₀ to the auxiliary surface ξⱼ, which might be represented by a modified CAD model. In the first step, the auxiliary surface ξⱼ is equal to the target surface x_{*} which is given by the original CAD model.
2. The second step comprises producing the workpiece with the surface x₀ using the theoretical path αⱼ₊₁ on the manufacturing machine and then measuring the resulting part surface xⱼ₊₁.
3. The third step comprises an update of the auxiliary surface ξⱼ by amending the corresponding CAD model or production model to compensate for the error of the measured workpiece surface xₖ.

With a single first workpiece, alternatively, an iterative scheme involving multi-step machining and measuring operations might be used. The corresponding iteration scheme reads

xⱼ₊₁=S(xⱼ,A(xⱼ,ξⱼ),β)

ξⱼ₊₁=ξⱼ−(xⱼ₊₁−x_{*})
with x₀, ξ₀=x_{*} and j=0, 1, . . . As the proposed update of the corrected target surface is basically the same as in the single-step case, one can introduce a generalization towards a PI controlled iteration as follows:

xⱼ₊₁=S(xⱼ,A(xⱼ,ξⱼ),β)

ξⱼ₊₁=ξⱼ+(Kₚ+Kᵢ)(xⱼ₊₁−x_{*})−Kₚ(xⱼ−x_{*})

The most general approach for obtaining an error corrected control program is producing multiple first workpieces in multiple steps. The two previous schemes may be merged as follows: For processing a particular first workpiece, its current state x can be used as the initial state for the next processing step. For determining the control parameters α for the current step, the state x of the current workpiece can be used as the initial state and the auxiliary state ξ of the preceding workpiece can be used as the target state. Denoting the part iteration with the index j and the process step iteration with the index i leads to the following iteration scheme

$${α}_{i , j} = A ( {x}_{i - 1 , j} , {ξ}_{i , j}^{aux} )$$

$${x}_{i , j} = S ( {x}_{i - 1 , j} , {α}_{i , j} , β )$$

$${ξ}_{i , j} = {ξ}_{i , j}^{aux} - ( {x}_{i , j} - {x}_{*} )$$

with i=1, 2, . . . and j=0, 1, . . . and x₀=x_{*}. Processing starts for every workpiece at the common initial state x₀. The auxiliary state

$${ξ}_{i , j}^{aux}$$

is initially chosen as

$${ζ}_{0 , 0}^{aux} = {x}_{*}$$

and then according to the rules

$$if i \leq {i}_{max} and j \neq 0$$

$${ξ}_{i , j}^{aux} = {ξ}_{i , j - 1}$$

$$else$$

$${ξ}_{i , j}^{aux} = {ξ}_{i - 1 , j}$$

The auxiliary state for the step i may be taken from the preceding workpiece j−1 as long as the current workpiece is not the first one and the step iteration is not too far advanced. Otherwise ξₐᵤₓ is taken from the previous step i−1 of the same workpiece j. The iteration thus turns into a single-workpiece, multi-step iteration after iₘₐₓ steps. The iteration scheme may thus be described as follows:
1. A theoretical machining path α_{i,j} is computed by a CAM module, by way of example, for transforming the initial workpiece surface x_{i-1,j} into target surface

$${ξ}_{i , j}^{aux} .$$

In contrast to the multiple-workpiece single-step scheme, the initial surface is the surface of the same workpiece j, but originates from the previous processing step i−1.
2. The second step comprises machining of the workpiece using the computed path α_{i,j} and starting at the result of the previous processing step x_{i-1,j}, and then measuring the resulting workpiece surface x_{i,j}.
3. The third step comprises an update of the auxiliary surface

$${ξ}_{i , j}^{aux}$$

by amending the corresponding CAD model or production model to compensate for the difference between the measured workpiece surface x_{i,j}. and the workpiece target surface.

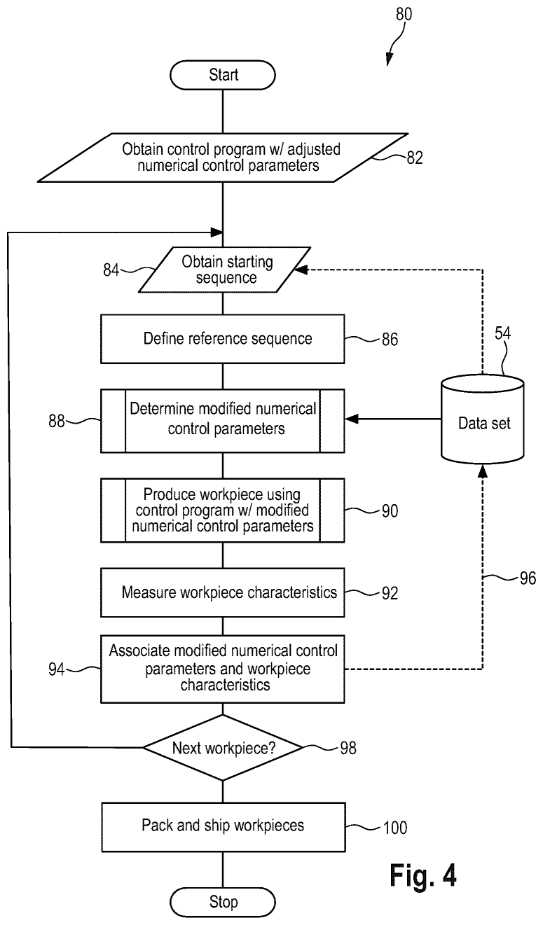

Once the numerical control parameters of the error corrected control program are finally adjusted according to step 78, second and further workpieces are produced in accordance with function block 80, which is explained in more detail in the following with reference to FIG. 4.

As shown in FIG. 4 at step 82, the control program comprising control commands and the numerical control parameters, as adjusted in accordance with the explanations above, is obtained. At step 84, a starting sequence wᵢₙᵢ of data pairs representing recent production runs on manufacturing installation 10 is obtained. The starting sequence wᵢₙᵢ has a predefined length Tᵢₙᵢ, i.e. it comprises a predefined number Tᵢₙᵢ of data pairs. A prediction horizon Tris selected. The Hankel matrix H_{L}(w_{d}) has a maximal rank for L=Tᵢₙᵢ+T_{f}.

In some example embodiments, one or more data pairs for the starting sequence wᵢₙᵢ may be taken from the first plurality of data pairs in data set 54. Therefore, one or more data pairs of starting sequence wᵢₙᵢ may originate from the calibration runs, if the next workpiece is among the first workpieces to be produced after the calibration runs. With ongoing use of manufacturing installation 10, however, the data pairs of starting sequence wᵢₙᵢ will differ from the data pairs of the calibration runs, which is expressed here be differentiating between past production runs used to form data set 54 and recent production runs used to form starting sequence wᵢₙᵢ. Some or all of the data pairs of the starting sequence may originate from the production of first workpieces in accordance with method 62, as explained with reference to FIG. 3.

At step 86, a reference sequence wᵣ=(uᵣ, rᵣ) of data pairs is determined from the desired workpiece characteristics and, by way of example, from the adjusted numerical control parameters. Alternatively, numerical control parameters already modified for previous production runs may be used, which is particularly advantageous if a series of workpieces of the same type and size is produced in successive production runs. In some example embodiments, reference sequence wᵣ may have a plurality of data pairs (uᵣ, yᵣ) that each are the same. The length of reference sequence wᵣ is preferably chosen to be the same as prediction horizon T_{f}. In any case, reference sequence wᵣ does not need to be a valid trajectory within the parameter space of manufacturing installation 10. Rather, it is a theoretical sequence of set values.

According to step 88, modified numerical control parameters are now determined by searching for a sequence w_{f}=(u_{f}, y_{f}) of data pairs that minimizes the expression

$${‖ {w}_{f} - {w}_{r} ‖}_{2}^{2} = {\sum }_{k = 1}^{{T}_{f}} {‖ {w}_{f}^{k} - {w}_{r}^{k} ‖}_{2}^{2}$$

and, additionally, is a valid continuation of starting sequence wᵢₙᵢ. The concatenation of sequence wᵢₙᵢ and sequence w_{f} has to form a valid sequence of length L=Tᵢₙᵢ+T_{f}. In this regard, one can say that concatenated sequences wᵢₙᵢ and w_{f} substantially can be derived as a linear combination of the sequences of data set 54. The optimization task can be solved by standard methods and quadratic solvers, such as https://osqp.org.

Preferably, the modified numerical control parameters of the first data pair of the sequence T_{f} are used for the next production run in accordance with step 90. According to step 92, the workpiece produced in step 90 using the modified numerical control parameters may be measured to determine its actual workpiece characteristics. According to step 94, the modified numerical control parameters and the actual workpiece characteristics may be associated to form a most recent data pair that may advantageously be used to update the starting sequence wᵢₙᵢ for the next production run, as it is indicated at reference numeral 96. However, it is conceivable to skip steps 90, 92 for a limited number of workpieces in a series production, if production cycle times are considerably shorter than process fluctuations. Accordingly, yet another workpiece may be produced in accordance with step 98.

In some embodiments, the new method may involve production of a repair inlay to repair spatially limited defects on the workpiece surface. The defect may be scanned using metrology device 24 and the scan data can be used for the production of the repair inlay. Additive manufacturing methods can advantageously be used for the production of the repair inlay.

The method according to FIG. 4 is based on the assumption that manufacturing installation 10 is a linear and time-invariant system and that the data is exact, i.e. not subject to noise. In case of unacceptably noisy data, there are several tools which can preferably be applied to overcome the issue. A simple one is to approximate the Hankel matrix using a low rank approximation computed from a singular value decomposition of H_{L}(w_{d}).

Another approach is to leave the Hankel matrix H_{L}(w_{d}) unaltered and to modify the optimization problem instead. These modifications target both noise in the initial data and in the representation data and comprise adding relaxation terms to the objective function and constraint relaxation by introducing penalized slack variables, as is suggested by Ivan Markovsky and Florian Dörfler in the publication “Behavioral systems theory in data-driven analysis, signal processing, and control” mentioned at the outset. Moreover, it has turned out that the method according to FIG. 4 also performs well for non-linear systems. In some example embodiments, the data set 54 may be updated from time to time in order to compensate for time variant behavior or non-linearities.

Advantageously, the concept explained with reference to FIG. 4 in the context of manufacturing a second and further workpieces may also be applied for determining an inspection plan for inspecting the first and second workpieces. It may be assumed that the result of the execution of an inspection plan can be described by a linear time-invariant state model

xₖ₊₁=Axₖ+Buₖ

yₖ=Cxₖ+Duₖ
with u being a vector of manipulatable parameters of the inspection plan, which vector is to be optimized. Input parameters may comprise measurement speed, in particular the speed of a measurement head moved relative to the workpiece. Reordering inspection plan elements, i.e. the order of workpiece features to be measured, can be integrated into these variables as well; y is a vector of the measurement results supplied by the metrology device executing the inspection plan; and x is an auxiliary variable with no direct interpretation. The inspection plan parameters u can be determined by minimizing the functional

$$J ( u ) = \frac{1}{n} {\sum }_{i = 1}^{n} {( {y}_{i} ( u ) - \overline{y} )}^{2}$$

$$with$$

$$\overline{y} = ( 1 / n ) {\sum }_{i} {y}_{i}$$

Minimizing J(u) advantageously leads to a reduction of measurement variance. Alternatively, suitable inspection plan can be determined using algorithms known to those skilled in the art from what is known as the traveling salesman problem and/or using algorithms used in air traffic management.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD or DVD). The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

1. A method of producing a plurality of workpieces using a manufacturing installation including a manufacturing machine having a moveable machine element, a machine controller configured to control the moveable machine element based on a control program, and a metrology device configured to record a plurality of measurement values on a produced workpiece in order to determine respective workpiece characteristics of the produced workpiece, the method comprising:
obtaining nominal workpiece data defining respectively desired workpiece characteristics for the plurality of workpieces;
obtaining a first control program based on the nominal workpiece data, the first control program including a plurality of first control commands and a plurality of first numerical control parameters, wherein the plurality of first numerical control parameters determine a respective kinematic behavior of the moveable machine element during operation;
producing a first workpiece of the plurality of workpieces using the moveable machine element, the machine controller and the first control program in a first production run;
inspecting the first workpiece using the metrology device in order to obtain first measurement values representing actual workpiece characteristics of the first workpiece;
determining production errors by comparing the actual workpiece characteristics of the first workpiece and desired workpiece characteristics;
adjusting the first control program based on the production errors to obtain an error corrected control program, the error corrected control program having adjusted numerical control parameters configured to compensate for the production errors;
obtaining a data set that includes:
a plurality of past numerical control parameters used during a plurality of past production runs on the manufacturing machine; and
a plurality of past measurement values recorded on past workpieces produced by the plurality of past production runs,
wherein the plurality of past numerical control parameters and the plurality of past measurement values are associated to each other based on the produced workpieces such that a first plurality of data pairs are formed, with each data pair of the first plurality of data pairs including past numerical control parameters and past measurement values resulting therefrom, and with the first plurality of data pairs representing a first temporal sequence of the plurality of past production runs;
obtaining a second plurality of data pairs that represent a temporal sequence of recent production runs, with each data pair of the second plurality of data pairs including respective actual numerical control parameters used during a respective one of the recent production runs and respective actual measurement values resulting therefrom;
defining a reference sequence of data pairs based on the adjusted numerical control parameters and based on nominal measurement values corresponding to the respectively desired workpiece characteristics;
determining individually modified numerical control parameters using the reference sequence of data pairs, using the data set including the first plurality of data pairs, and using the second plurality of data pairs, wherein the second plurality of data pairs are used as a starting sequence, and wherein the individually modified numerical control parameters define at least one data pair that extends the starting sequence based on the first plurality of data pairs and based on the nominal measurement values from the reference sequence of data pairs; and
producing a second workpiece of the plurality of workpieces using the moveable machine element, the machine controller and the error corrected control program in a second production run, wherein the individually modified numerical control parameters are used instead of the adjusted numerical control parameters.

2. The method of claim 1, further comprising:
recording second measurement values on the second workpiece;
associating the individually modified numerical control parameters used for production of the second workpiece and the second measurement values to form a most recent data pair;
adding the most recent data pair to the second plurality of data pairs to form an updated temporal sequence of recent production runs; and
producing a third workpiece of the plurality of workpieces using the moveable machine element, the machine controller and the error corrected control program in a third production run, wherein:
further individually modified numerical control parameters are used instead of the adjusted numerical control parameters; and
the further individually modified numerical control parameters are determined using (i) the reference sequence of data pairs, (ii) the data set including the first plurality of data pairs, and (iii) the updated temporal sequence of recent production runs.

3. The method of claim 2, wherein the first workpiece, the second workpiece and the third workpiece are individual specimens of a same type of workpiece.

4. The method of claim 1, wherein:
a plurality of first workpieces are iteratively produced using the moveable machine element and inspected using the metrology device;
production errors are determined for each of the plurality of first workpieces; and
adjusting the first control program is iteratively carried out based on a respective one of the plurality of first workpieces at a time.

5. The method of claim 1, wherein:
the first workpiece is produced in a plurality of production steps each using the moveable machine element;
the first workpiece is iteratively inspected using the metrology device after each of the plurality of production steps; and
adjusting the first control program is iteratively carried out based on the production errors after each of the plurality of production steps.

6. The method of claim 4, wherein iteratively adjusting the first control program includes determining the adjusted numerical control parameters in accordance with a feedback-based control loop mechanism having an integral control term.

7. The method of claim 6, wherein iteratively adjusting the first control program includes determining the adjusted numerical control parameters in accordance with a feedback-based control loop mechanism further having a proportional control term.

8. The method of claim 1, wherein:
the first plurality of data pairs includes a plurality of calibration data pairs recorded during a plurality of selected calibration runs using the manufacturing machine, and
the plurality of calibration data pairs each includes numerical control parameters individually modified in accordance with a calibration strategy.

9. The method of claim 8, wherein the calibration strategy includes deliberately changing the numerical control parameters from one calibration production run to another calibration production run of the plurality of selected calibration runs.

10. The method of claim 1, wherein defining the reference sequence of data pairs includes determining a plurality of reference data pairs each including the adjusted numerical control parameters and the nominal measurement values.

11. The method of claim 1, wherein:
determining the individually modified numerical control parameters includes determining a plurality of modified numerical control parameters in a sequential order having a start; and
modified numerical control parameters from the start of the sequential order are selected for producing the second workpiece.

12. The method of claim 1, wherein:
the first temporal sequence of the past production runs is subdivided into a plurality of past temporal subsequences using a sliding window procedure;
the plurality of past temporal subsequences from the data set are arranged in a Hankel matrix; and
the individually modified numerical control parameters are determined in such a manner that data pairs including the individually modified numerical control parameters are determined based on an image of the Hankel matrix.

13. The method of claim 1, wherein the first plurality of data pairs is updated at defined intervals using the individually modified numerical control parameters.

14. A manufacturing installation for producing a plurality of workpieces, the manufacturing installation comprising:
a manufacturing machine having a moveable machine element;
a machine controller configured to control the moveable machine element based on a control program; and
a metrology device configured to record a set of measurement values on a produced workpiece in order to determine workpiece characteristics of the produced workpiece,
wherein the machine controller includes at least one processor configured to:
obtain nominal workpiece data defining respectively desired workpiece characteristics for the plurality of workpieces,
obtain a first control program based on the nominal workpiece data, the first control program including a plurality of first control commands and a plurality of first numerical control parameters, wherein the plurality of first numerical control parameters determine a respective kinematic behavior of the moveable machine element during operation,
produce a first workpiece of the plurality of workpieces using the moveable machine element, the machine controller and the first control program in a first production run,
inspect the first workpiece using the metrology device in order to obtain first measurement values representing actual workpiece characteristics of the first workpiece,
determine production errors by comparing the actual workpiece characteristics of the first workpiece and desired workpiece characteristics,
adjust the first control program based on the production errors to obtain an error corrected control program, the error corrected control program having adjusted numerical control parameters configured to compensate for the production errors,
obtain a data set that includes a plurality of past numerical control parameters used during a plurality of past production runs on the manufacturing machine and includes a plurality of past measurement values recorded on past workpieces produced by the plurality of past production runs, wherein the plurality of past numerical control parameters and the plurality of past measurement values are associated to each other based on the produced workpieces such that a first plurality of data pairs are formed, with each data pair of the first plurality of data pairs including past numerical control parameters and past measurement values resulting therefrom, and with the first plurality of data pairs representing a first temporal sequence of the plurality of past production runs,
obtain a second plurality of data pairs that represent a temporal sequence of recent production runs, with each data pair of the second plurality of data pairs including respective actual numerical control parameters used during a respective one of the recent production runs and respective actual measurement values resulting therefrom,
obtain a reference sequence of data pairs based on the adjusted numerical control parameters and based on nominal measurement values corresponding to the respectively desired workpiece characteristics,
determine individually modified numerical control parameters using the reference sequence of data pairs, the data set including the first plurality of data pairs, and the second plurality of data pairs, wherein:
the second plurality of data pairs are used as a starting sequence; and
the individually modified numerical control parameters define at least one data pair that extends the starting sequence based on the first plurality of data pairs and based on the nominal measurement values from the reference sequence of data pairs, and
produce a second workpiece of the plurality of workpieces using the moveable machine element, the machine controller and the error corrected control program in a second production run, wherein the individually modified numerical control parameters are used instead of the adjusted numerical control parameters.

15. A non-transitory computer-readable medium comprising program code that performs, in response to executing the program code on at least one processor of a manufacturing installation having a moveable machine element and a metrology device configured to record a plurality of measurement values on a produced workpiece:
obtaining nominal workpiece data defining respectively desired workpiece characteristics for a plurality of workpieces,
obtaining a first control program based on the nominal workpiece data, the first control program including a plurality of first control commands and a plurality of first numerical control parameters, wherein the plurality of first numerical control parameters determine a respective kinematic behavior of the moveable machine element during operation,
producing a first workpiece of the plurality of workpieces using the moveable machine element, a machine controller and the first control program in a first production run,
inspecting the first workpiece using the metrology device to obtain first measurement values representing actual workpiece characteristics of the first workpiece,
determining production errors by comparing the actual workpiece characteristics of the first workpiece and desired workpiece characteristics,
adjusting the first control program based on the production errors to obtain an error corrected control program, the error corrected control program having adjusted numerical control parameters configured to compensate for the production errors,
obtaining a data set that includes a plurality of past numerical control parameters used during a plurality of past production runs on the device and includes a plurality of past measurement values recorded on past workpieces produced by the plurality of past production runs, wherein the plurality of past numerical control parameters and the plurality of past measurement values are associated to each other based on the produced workpieces such that a first plurality of data pairs are formed, with each data pair of the first plurality of data pairs including past numerical control parameters and past measurement values resulting therefrom, and with the first plurality of data pairs representing a first temporal sequence of the plurality of past production runs,
obtaining a second plurality of data pairs that represent a temporal sequence of recent production runs, with each data pair of the second plurality of data pairs including respective actual numerical control parameters used during a respective one of the recent production runs and respective actual measurement values resulting therefrom,
defining a reference sequence of data pairs based on the adjusted numerical control parameters and based on nominal measurement values corresponding to the respectively desired workpiece characteristics,
determining individually modified numerical control parameters using the reference sequence of data pairs, using the data set including the first plurality of data pairs, and using the second plurality of data pairs, wherein:
the second plurality of data pairs are used as a starting sequence; and
the individually modified numerical control parameters define at least one data pair that extends the starting sequence based on the first plurality of data pairs and based on the nominal measurement values from the reference sequence of data pairs, and
producing a second workpiece of the plurality of workpieces using the moveable machine element, the machine controller and the error corrected control program in a second production run, wherein the individually modified numerical control parameters are used instead of the adjusted numerical control parameters.
